(19) United States
(12) Patent Application Publication
(10) Pub. No.: US 2018/0133872 A1
(43) Pub. Date: May 17, 2018

(54) ELECTRIC POWER TOOL AND METHOD FOR OPERATING THE SAME

(71) Applicant: MOBILETRON ELECTRONICS CO., LTD., TAICHUNG CITY (TW)

(72) Inventor: KIM Y.C. TSAI, TAICHUNG CITY (TW)

(73) Assignee: MOBILETRON ELECTRONICS CO., LTD., TAICHUNG CITY (TW)

(21) Appl. No.: 15/802,982

(22) Filed: Nov. 3, 2017

(30) Foreign Application Priority Data
Nov. 15, 2016 (TW) 105137201

(51) Int. Cl. B25B 23/142; B23Q 17/00; B25B 23/147; H04W 4/00

(52) U.S. Cl. CPC B25B 23/1425; B23Q 17/008; G05B 2219/25206; H04W 4/008; B25B 23/1475

(57) ABSTRACT

An electric power tool includes a wireless module, a controller, a stage-selection module, a trigger switch, a driver and a driving motor. The method for operating the electric power tool includes steps of receiving a wireless signal from the outside via the wireless module, wherein the wireless signal includes a plurality of control parameters; storing the control parameters into the memory; upon receiving a stage-selection signal, extracting a control parameter in accordance with the stage-selection signal from the memory; upon receiving a triggering signal, outputting a control signal to the driver so as to drive the driving motor, wherein the control signal is output based on a torque value of at least one control parameter which is corresponding to the stage-selection signal. It allows a user to change the settings of the electric power tool via wireless communication, thereby increasing the flexibility of using the electric power tool.

### BACKGROUND OF THE INVENTION

### 1. Technical Field

The present invention is related to a portable electric power tool, and more particularly to an electric power tool which could transmit control parameters via wireless communication and a method for operating the same.

### 2. Description of Related Art

Conventional electric power tools, such as electric screwdrivers or electric drills, usually include a controller, a driving motor, and a power-output mechanism. The controller is electrically connected to the driving motor, while the driving motor is connected to the power-output mechanism. The controller is stored with at least one set of control parameters capable of controlling the driving motor to run correspondingly, and thereby to make the power-output mechanism provide an output power.

The control parameters of the conventional electric power tools have been set by the manufacturers in the factory, so that the user only can purchase the specific electric power tool which could meet the output power requirement. When the output power of the electric power tool is not consistent with the output power required by the working piece, such as the output power of the electric power tool is too high or too low, it is necessary for the user to use another electric power tool to continue his working process. Even there are some kinds of electric power tools having multi-stages of output powers in the current market which makes it be more flexible on using the electric power tools, it may occur that the output power required by the working piece is fallen between the output powers of the two stages of the electric power tool. Under such a circumstance, the user still has to seek for another suitable electric power tool. Therefore, there is still a need to improve the design of the conventional electric power tools.

### BRIEF SUMMARY OF THE INVENTION

In view of the above, the present invention is to provide an electric power tool and a method for operating the same which enables a user to set up control parameters with a wireless connection method.

The present invention provides an electric power tool including a wireless module, a controller, a stage-selection module, a trigger switch, a driver and a driving motor. Wherein, the wireless module is adapted to receive a wireless signal having a plurality of control parameters from the outside and to output the plurality of control parameters; each of the plurality of control parameters includes a stage and a torque value corresponding to the stage, and the torque values corresponding to each of the stages are different. The controller is electrically connected with the wireless module and adapted to receive the plurality of control parameters from the wireless module and to store the plurality of control parameters into a memory. The stage-selection module is electrically connected to the controller and adapted to be operated to generate a stage-selection signal to be transmitted to the controller, wherein the stage-selection signal is corresponding to a stage which at least one of the plurality of control parameters belongs to; the controller selects the at least one of the plurality of control parameters in accordance with the stage-selection signal after receiving the stage-selection signal. The trigger switch is electrically connected to the controller and adapted to be triggered to generate a triggering signal to be transmitted to the controller, wherein after receiving the triggering signal, the controller outputs a control signal based on a torque value of the at least one of the plurality of control parameters which is corresponding to the stage-selection signal. The driver is electrically connected to the controller and adapted to receive the control signal from the controller so as to generate a driving signal. The driving motor is electrically connected to the driver and adapted to receive the driving signal and to run in response to the driving signal.

The present invention further provides a method for operating the electric power tool. The method includes steps of (a) receiving a wireless signal from the outside via the wireless module, wherein the wireless signal includes a plurality of control parameters; each of the plurality of control parameters includes a stage and a torque value corresponding to the stage; the torque values corresponding to each of the stages are different; (b) receiving the plurality of control parameters and storing the plurality of control parameters into the memory; (c) upon receiving a stage-selection signal, extracting a control parameter in accordance with the stage-selection signal from the memory, wherein the stage-selection signal is corresponding to a stage which at least one of the plurality control parameters belongs to; and (d) upon receiving a triggering signal, outputting a control signal to the driver to drive the driving motor to run correspondingly, wherein the control signal is output based on a torque value of the at least one of the control parameters which is corresponding to the stage-selection signal.

Accordingly, the advantage of the present invention is that the user could change the settings of the electric power tool by utilizing the wireless module to receive the external control parameters. It is more flexible for the user to use the electric power tool 100 and is effective to improve the drawbacks of the conventional electric power tools which include fixed control parameters.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of an electric power tool of an embodiment according to the present invention; and

FIG. 2 is a flow-chart illustrating the method for operating the electric power tool of the embodiment according to the present invention.

### DETAILED DESCRIPTION OF THE INVENTION

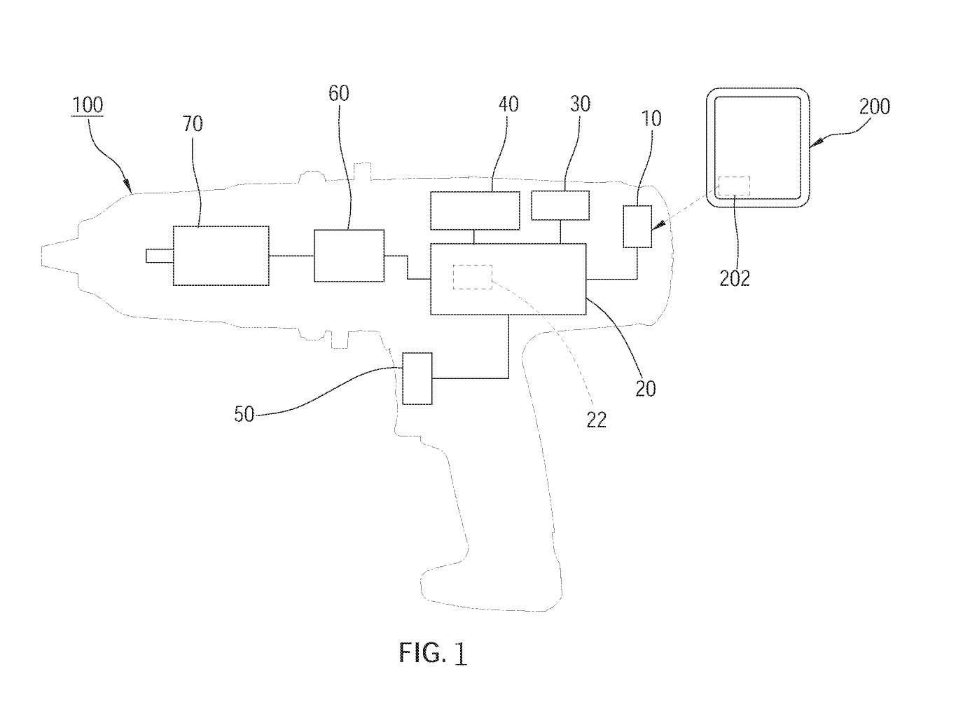

One embodiment of an electric power tool in accordance with the present invention will now be described with reference to the accompanying drawings. Referring to FIG. 1, an electric power tool 100 of an embodiment according to the present invention is disclosed. The electric power tool 100 is a portable-type electric power tool adapted to be used with a mobile device 200, wherein the mobile device 200 is a smartphone as an example. The mobile device 200 includes a wireless communication module 202. In this embodiment, the wireless communication module 202 can be, for example, a Near Field Communication (NFC) unit, but it is not a limitation of the present invention. In other embodiments, the wireless communication module 202 can be infrared, Bluetooth, ZigBee or WiFi wireless communication methods. The mobile device 200 executes an application stored therein. The application is adapted to receive an identifier of the electric power tool 100 from user input. The identifier includes at least one of a model number, a serial number, and a brand name of a compatible electric power tool. In addition, the application is also provided for the user to input at least one control parameter to be set. In this embodiment, the user can input a plurality of control parameters. Each of the control parameters includes a stage and a torque value corresponding to the stage. Wherein, each of the control parameters belongs to a stage which is different from the stages of other control parameters, and the torque values corresponding to each of the stages are different. In practice, when there is only one control parameter, the control parameter can include no stages. The mobile device 200 could send a wireless signal including the identifier and at least one control parameter via the wireless communication module 202.

The electric power tool 100 includes a wireless module 10, a controller 20, a stage-selection module 30, a display module 40, a trigger switch 50, a driver 60 and a driving motor 70.

In this embodiment, the wireless module 10 is a Near Field Communication (NFC) unit as an example, which can communicate with the wireless communication module 202 of the mobile device 200. The wireless module 10 is adapted to receive the external wireless signal which includes the identifier and the at least one control parameter and to output the identifier and the control parameter.

The controller 20 can be, for example, a microprocessor, and is electrically connected to the wireless module 10. In this embodiment, the controller 20 includes a built-in memory 22. In practice, the memory 22 can be independently located in the electric power tool 100, rather than being built in the controller 20. The memory 22 is stored with an identifier (hereinafter referred to as a first identifier) and a predetermined torque range of the electric power tool 100 in advance. Wherein, the first identifier includes at least one of a model number, a serial number and a brand name of the electric power tool 100. In this embodiment, the first identifier includes the model number and the brand name. The predetermined torque range includes an upper limit and a lower limit which respectively refer to a maximum torque value and a minimum torque value of the electric power tool 100.

The stage-selection module 30, the display module 40, the trigger switch 50 and the driver 60 are electrically connected to the controller 20 respectively, while the driver 60 is further electrically connected with the driving motor 70. In this embodiment, the stage-selection module 30 includes at least one switch. The stage-selection module could be operated by the user to generate a stage-selection signal to be output to the controller 20. In practice, the stage-selection module 30 also can include a rotatable button which could be operated by the user. The display module 40 is controlled by the controller 20 to display information for the user. The trigger switch 50 is triggered by the user to generate a triggering signal to be output to the controller 20. The driver 60 is adapted to receive a control signal from the controller 20 and generate a driving signal to the driving motor 70 based on the control signal so as to control the driving motor 70 to run and make a power-output mechanism (not shown) connected thereto output a corresponding torque.

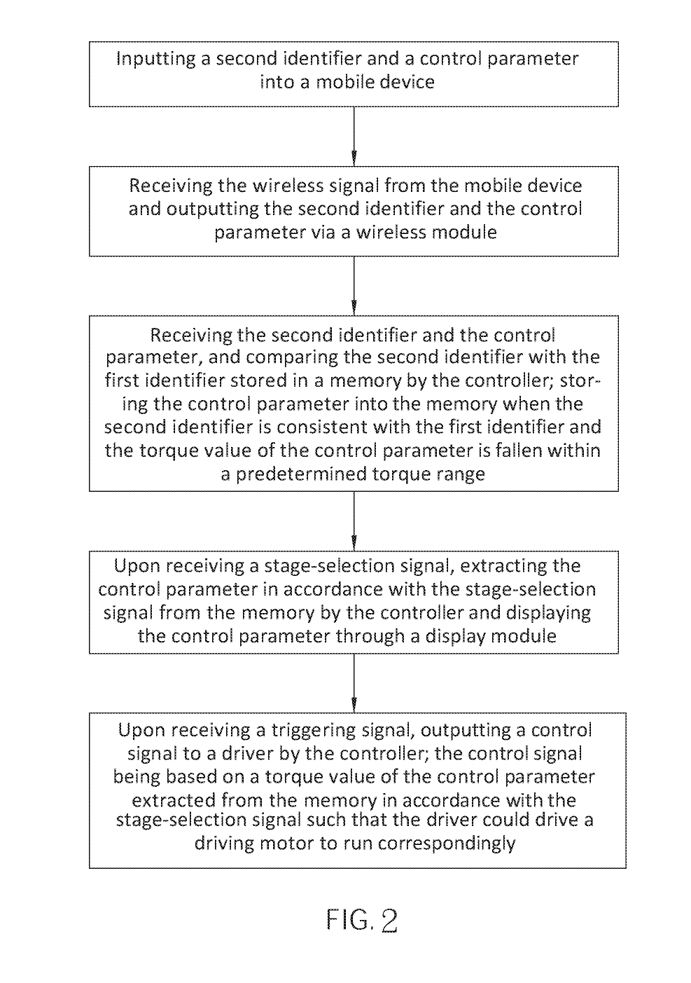

With the structures mentioned above, a method for operating the electric power tool 100 of the embodiment is shown in FIG. 2. The method includes the following steps:

First, a user executes the application installed on the mobile device 200 and inputs the identifier of the electric power tool (hereinafter referred to as a second identifier) with a stage of each control parameter and a torque value corresponding to the stage into the mobile device 200. Wherein, the torque value could be arbitrarily set by the user as long as the torque value being set is fallen within the predetermined torque range. For example, in this embodiment, the second identifier includes the brand name and the model number of the electric power tool 100. The user can set a first control parameter to have a stage of “1”, i.e., the first stage, and a corresponding torque value of 5 Nm, and set a second control parameter to have a stage of “2”, i.e., a second stage, and a corresponding torque value of 10 Nm, etc. Next, by holding the mobile device 200 to be close to the electric power tool 100, the NFC connection can be established between the wireless communication module 202 of the mobile device 200 and the wireless module 10 of the electric power tool 100, so that the wireless communication module 202 of the mobile device 200 could send the wireless signal including the second identifier and the control parameters to the wireless module 10 of the electric tool 100.

Then, by receiving the wireless signal from the mobile device 200 via the wireless module 10, the wireless module 10 could obtain the second identifier and the control parameters included in the wireless signal, and thereby to output the information to the controller 20.

After receiving the second identifier and the control parameters, the controller 20 would compare the second identifier with the first identifier stored in the memory 22 to determine whether the second identifier is consistent with the first identifier stored or not.

If not, the controller 20 would ignore the control parameters and control the display module 40 to display an error message, such as a wrong brand name or an incompatible model number.

If yes, the controller 20 would further compare the torque values of the control parameters with the predetermined torque range stored in the memory 22. When the torque values are fallen within the predetermined torque range, the controller 20 would store the control parameters into the memory 22. In contrast, if any one of the torque values of the control parameters is not within the predetermined torque range, the controller 20 would ignore the control parameters and display an error message, such as an inconsistent torque value, through the display module 40.

In this way, the steps for setting the control parameters of the electric power tool 100 are completed, and the electric power tool 100 could be set with at least one stage and one corresponding torque by the user himself.

In practice, the step for determining whether the torque values are fallen within the predetermined torque range also can be proceeded by the mobile device 200. For example, the mobile device 200 can be stored with the brand names, the model numbers and the corresponding torque ranges of different kinds of electric power tools in advance. The application on the mobile device 200 could be executed to determine whether the torque value input by the user is within the predetermined torque range of the electric power tool 100. When the user input is consistent with the information stored in the mobile device 200, the second identifier and the control parameters are then sent out by the mobile device 200. Whereby, the step for comparing the torque value with the predetermined torque value range by the controller 20 could be omitted. In addition, it is not necessary for the mobile device 200 to send out the second identifier, and the step for the controller to compare the first identifier and the second identifier also could be omitted as well.

To use the electric power tool 100, the user could touch a switch of the stage-selection module 30 to generate a stage-selection signal to be transmitted to the controller 20. The stage-selection signal is corresponding to a stage which at least one of the control parameters belongs to. After receiving the stage-selection signal, the controller 20 extracts the control parameter in accordance with the stage-selection signal from the memory 22, and interpret the torque value of the control parameter into a data format which could be received by the display module 40. Thereby, the stage and the corresponding torque value of the selected control parameter are displayed through the display module 40. For example, when the first control parameter is selected, then a corresponding message of “First stage/Torque value: 5 Nm” would be displayed on the display module.

Thereafter, the controller 20 would be waited to receive a triggering signal. When the user triggers the trigger switch 50, the triggering signal would be generated and transmitted to the controller 20. Upon receiving the triggering signal, the controller 20 would output a control signal to the driver 60 based on the torque value of the corresponding control parameter extracted from the memory 22 in accordance with the stage-selection signal. For example, when the first control parameter is chosen, the torque value “5 Nm” is interpreted as a control signal by the controller 20. The control signal includes information of a machine weight, a rotary shaft mass, and at least one or a combination of parameters, such as a rotation speed, a running time, an acceleration speed and an electric current value, for driving the driving motor 70. Thereby, the driver 60 could drive the driving motor 70 to rotate correspondingly. Wherein, the driver 60 would convert the control signal into an analog-type driving signal for driving the driving motor 70, so that the driving motor 70 could be driven to rotate and thereby the electric power tool 100 would have an output power which meets the selected torque value.

As mentioned above, according to the present invention, it enables the user to set the parameters of the electric power tool 100 through the mobile device 200 depending on his requirement by providing a wireless module 10 capable of receiving external control parameters on the electric power tool 100. Whereby, it is more flexible for the user to use the electric power tool 100 and greatly improve the drawbacks of the conventional electric power tools which only have fixed output powers.

It must be pointed out that the embodiments described above are only some embodiments of the present invention. All equivalent structures which employ the concepts disclosed in this specification and the appended claims should fall within the scope of the present invention.

What is claimed is:

1. An electric power tool, comprising:
a wireless module, adapted to receive a wireless signal having a plurality of control parameters from the outside and to output the plurality of control parameters, wherein each of the plurality of control parameters includes a stage and a torque value corresponding to the stage, and the torque values corresponding to each of the stages are different;
a controller, electrically connected to the wireless module and adapted to receive the plurality of control parameters from the wireless module and to store the plurality of control parameters into a memory;
a stage-selection module, electrically connected to the controller and adapted to be operated to generate a stage-selection signal to be transmitted to the controller, wherein the stage-selection signal is corresponding to a stage which at least one of the plurality of control parameters belongs to; the controller selects the at least one of the plurality of control parameters in accordance with the stage-selection signal after receiving the stage-selection signal;
a trigger switch, electrically connected to the controller and adapted to be triggered to generate a triggering signal to be transmitted to the controller, wherein after receiving the triggering signal, the controller outputs a control signal based on a torque value of the at least one of the plurality of control parameters which is corresponding to the stage-selection signal;
a driver, electrically connected to the controller and adapted to receive the control signal from the controller so as to generate a driving signal; and
a driving motor, electrically connected to the driver, and adapted to receive the driving signal and to run in response to the driving signal.

2. The electric power tool of claim 1, wherein the wireless module includes a Near Field Communication (NFC) unit.

3. The electric power tool of claim 1, further comprising a display module electrically connected to the controller; the controller controls the display module to display the torque value corresponding to the at least one of the plurality of control parameters after receiving the stage-selection signal.

4. The electric power tool of claim 1, wherein a first identifier is stored in the memory, while the wireless signal includes a second identifier; the controller receives the second identifier from the wireless module and compares the second identifier with the first identifier; when the second identifier is consistent with the first identifier, the controller stores the at least one of the plurality of control parameters into the memory.

5. The electric power tool of claim 4, wherein a predetermined torque range is stored in the memory; the controller compares the torque values corresponding to the plurality control parameters with the predetermined torque range; when the first identifier is consistent with the second identifier, and the torque values are within the predetermined torque range, the controller stores the plurality of control parameters into the memory.

6. A method for operating an electric power tool, wherein the electric power tool includes a wireless module, a memory, a driver and a driving motor, the method comprising:
receiving a wireless signal from the outside via the wireless module, wherein the wireless signal includes a plurality of control parameters; each of the plurality of control parameters includes a stage and a torque value corresponding to the stage; the torque values corresponding to each of the stages are different;
receiving the plurality of control parameters and storing the plurality of control parameters into the memory;
upon receiving a stage-selection signal, extracting a control parameter in accordance with the stage-selection signal from the memory, wherein the stage-selection signal is corresponding to a stage which at least one of the plurality control parameters belongs to; and
upon receiving a triggering signal, outputting a control signal to the driver to drive the driving motor to run correspondingly, wherein the control signal is output based on a torque value of the at least one of the control parameters which is corresponding to the stage-selection signal.

7. The method of claim 6, wherein the step of receiving the wireless signal utilizes a Near Field Communication method.

8. The method of claim 6, wherein the electric power tool further includes a display module, and the step of receiving the stage-selection signal further comprises a step of at least displaying the torque value of the control parameters being extracted on the display module.

9. The method of claim 6, wherein the electric power tool includes a first identifier and the wireless signal includes a second identifier; the step of receiving the plurality of control parameters further comprises steps of receiving the second identifier, comparing the first identifier with the second identifier, and storing the plurality of control parameters into the memory when the first identifier is consistent with the second identifier.

10. The method of claim 9, wherein the electric power tool includes a predetermined torque range; the step of receiving the plurality of control parameters further comprises steps of comparing the torque values corresponding to each of the plurality of control parameters with the predetermined torque range, and storing the plurality of control parameters into the memory when the torque values are within the predetermined torque range.

11. The method of claim 10, wherein before the step of receiving the wireless signal, the method further comprises a step of inputting the second identifier, the stages corresponding to each of the plurality of control parameters, and the torque values related to the stages into a mobile device; the step of receiving the wireless signal further comprises sending out the wireless signal which includes the second identifier and the plurality of control parameters via the mobile device.
